(19) United States
(12) Patent Application Publication
(10) Pub. No.: US 2026/0058069 A1
(43) Pub. Date: Feb. 26, 2026

(54) ELECTROPHYSICAL DIRECT ENERGY CONVERTER (EDEC)

(71) Applicants: Frank E Gordon, San Diego, CA (US); Harper J Whitehouse, San Diego, CA (US)

(72) Inventors: Frank E Gordon, San Diego, CA (US); Harper J Whitehouse, San Diego, CA (US)

(21) Appl. No.: 19/308,093

(22) Filed: Aug. 22, 2025

Related U.S. Application Data
(60) Provisional application No. 63/687,180, filed on Aug. 26, 2024.

(51) Int. Cl. H01G 9/20; H01G 9/042

(52) U.S. Cl. CPC H01G 9/2009; H01G 9/042

(57) ABSTRACT

Disclosed is an Electrophysical Direct Energy Converter (EDEC) device to convert electrophysical material energy into electricity based on the electrification of initially physically separated electrodes with different work functions and different Fermi levels. When the electrodes are electrically connected together, electrons will transfer from the low work function electrode to the high work function electrode to equilibrate their Fermi levels, whereby the high work function electrode has more electrons than its natural state, and the low work function electrode has fewer electrons than its natural state. If an electrolyte is in electrical contact with the electrodes and there is sufficient energy to transfer an electron from the high work function electrode to the electrolyte, the Fermi levels of the electrodes revert to their natural state by transporting charge through the electrolyte. Accordingly, additional electrical charge flows through the electrical connection to produce a continuous electrical voltage across and a current through the connection.

### CROSS REFERENCE TO RELATED APPLICATIONS

This application claims the benefit of U.S. Provisional Patent Application No. 63/687,180 filed on Aug. 26, 2024, the content of which is fully incorporated by reference herein.

### BACKGROUND OF THE INVENTION

### 1. Field of the Invention

This invention relates to an electrophysical direct energy converter (EDEC) device for the spontaneous direct energy conversion of thermal, metallurgical, and quantum electrophysical properties between two physically separated electrodes with different work functions and different Fermi levels when the electrodes are electrically connected together and in electrical contact with an electrolyte to exchange and transport charge. Electrical energy input, naturally radioactive materials, and chemical reactions are not required by the device.

### 2. Background Art

The science of electricity has been studied for several thousand years. A few selected discoveries that contribute to the discovery and operation of an electrophysical direct energy converter (EDEC) device are described below:

In 600 BCE, a Greek mathematician and philosopher named Thales of Miletus (c.624-546 BCE) discovered the basic principle of triboelectric static electricity when a rod made of amber (a fossilized tree resin) was rubbed with fur, it could be used to pick up light objects, such as bits of feathers. At that time, electricity was still just a “magical” curiosity—of very little practical use. [https://www.explainthatstuff.com/history-of-electricity.html] Since that discovery, many scientists have contributed to the knowledge and understanding of electricity.

Englishman Sir William Watson (1715-1787) developed the concept of electric circuits (closed paths around which charge flows) and made an important distinction between conductors and insulators. Benjamin Franklin (1706-1790) confirmed that there is a single “electric fluid,” giving rise to two “kinds” of electricity, which he named (as is still used today) “positive” and “negative.” Franklin also conducted his famous kite experiment in 1752 when he demonstrated the electrical nature of lightning by flying a kite during a thunderstorm. Franklin's observations led him to propose the idea of the lightning rod. For a given electric potential, the smaller the object, the greater the surface charge density and the greater the electric field. At a sharp point, the electric field can be huge. In such a large field, not only do the electrons acquire enough energy to ionize surrounding air molecules but those ionized air molecules, even in their short mean free paths, can acquire enough energy to ionize other air molecules. In addition, if the point is negatively charged, it is possible for electrons to be emitted from the surface.

Italian physicist Alessandro Volta (1745-1827), showed ca 1800 that when two dissimilar metals are brought into electrical contact with each other, the two metals will redistribute their electrons and produce different charges on an electroscope depending upon which of the contacted metals was measured. In modern terminology, Volta connected together two metals with different work functions and measured a contact potential difference (CPD) by inference from the electroscope readings. When an electrolyte, such as water or water-soaked cardboard, was placed in electrical contact with the different materials, Volta showed that a continuous current would flow through their electrical connection. Although Volta was initially studying electrophysical contact electrification, he accidentally discovered electrochemical reactions that were produced when different materials such as silver and zinc were substituted for silver and tin and separated by pieces of cardboard soaked in saltwater or lye (NaOH). This discovery led to the invention of the electrochemical battery—an important invention that revolutionized the history of electricity.

Scottish chemist, Thomas Graham, FRS, (1805-1869), is known for his studies on the behavior of gases which resulted in his formulation of two relationships, the first regarding gas diffusion and the second regarding gas effusion. Both have since become known as “Graham's laws.” Graham became the Master of the Royal Mint from 1855 until his death. During his tenure, he conducted experiments with exotic metals, including palladium and created trial pieces for the mint. In 1863, Henri Sainte-Claire Deville and L. Troost (Platinum Metals Rev., 1958, 2, (1), 16-22), had shown that hydrogen diffused rapidly through homogeneous plates of fused iron and platinum. Building on their work, Graham showed that palladium became permeable to hydrogen at 240° C. and, at a slightly higher temperature, the rate of diffusion was several cc per minute. Graham used the word “occluded” to differentiate how hydrogen atoms are positioned in the palladium lattice. Unlike metal hydrides, which are compounds formed by metals covalently bonded with hydrogen, the H⁺ hydrogen atoms that are occluded in the lattice contribute electrons to, and greatly increase, the number of electrons in the conduction band of the material.

In 1873, James Clerk Maxwell (1831-1879) published a complete theory of electromagnetism, neatly summarizing everything that was then known about electricity and magnetism in four apparently simple mathematical equations. This led to the invention of the electricity generator which provides most of the electricity used today. Maxwell teamed with physicist and mathematician Ludwig Boltzmann (1844-1906) to develop the general law for the distribution of energy among the various parts of a system at a specific temperature and derived the theorem of equipartition of energy known as the Maxwell-Boltzmann distribution law.

In the late 1800's, Nobel Laureates J. J. Thomson, (1856-1940), and E. Rutherford, (1871-1937) and others studied the conduction of electricity through a gas that was being ionized by X-rays discovered by Rontgen or by rays from radioactive materials that had been discovered by Becquerel a few years earlier. In addition, Thomson derived the equations governing the conduction of electricity through an ionized gas that included electric field drift but no diffusion. However, it was not until 1903 when the German experimental physicist E. Riecke published the complete set of conduction equations including both terms for ion concentration induced diffusion as well as the electric field induced drift of the ions. For most researchers, the application of an external electric field minimized the significance of the diffusion terms in the equations, and diffusion has mostly been ignored as being insignificant. Building on the work of Thomson and others, J. Townsend studied the conduction of electrons in low pressure gas in the presence of an electric field leading to the development of neon lights and ultimately fluorescent lights.

While these inventions were significant, Volta's discovery of electrochemical reactions leading to the battery diverted attention away from the basic study of contact electrification and electrophysical conduction which had motivated his original research. Similarly, the work by Thomson and Townsend minimized the significance of diffusion and diverted attention away from the diffusion of ions. In 1916, Nobel Laureate I. Langmuir published descriptions of experimental results wherein he showed that it was possible to conduct a current between dissimilar electrodes possessing a contact potential difference (CPD) as long as the dissimilar electrodes were in contact with an ionized gas and the energy for the conduction of electricity was supplied by the energy necessary to maintain the ionization of the gas. In 1932, K. K. Darrow published a book wherein he described the conduction of ions under both the influence of ion density gradients (diffusion) and an electric field (drift). Darrow also recognizes that due to the diffusion terms in the equations, these conduction processes may be non-ohmic in that the voltage and current do not need to go to zero together.

Although primarily known for being the creator of the world's first nuclear reactor, the Chicago Pile-1, and a member of the Manhattan Project, naturalized American Nobel Laureate Enrico Fermi (1901-1954) was also known for his work in quantum physics. Among his discoveries are the Fermi levels and Fermi energies of different materials. The Fermi level is a measure of the energy of the least tightly held electrons within a solid which is important in determining the electrical and thermal properties of solids. When two materials with different Fermi levels are in electrical contact, their Fermi levels will equilibrate to an unnatural state where one material has more electrons and the other material has fewer electrons than in its natural states. Fermi's observations formalized and explained Langmuir's descriptions of contact potential difference and the charge equilibration process. Along with the addition of the Maxwell-Boltzmann statistics, these observations form the basis for a model that is key to understanding the production of electrical current by an EDEC.

### SUMMARY OF THE INVENTION

The present invention incorporates improvements in the inventions we described in our U.S. Pat. No. 10,767,271 (Sep. 8, 2020), 10,841,989 (Nov. 17, 2020), and 11,232,880 (Jan. 25, 2022) and Application Publication No. 2024/0274372 which is still pending. Our invention functions to improve and generalize the performance of the Lattice Energy Converter (LEC) described in our aforementioned U.S. Pat. No. 11,232,880 by using an electrolyte other than an ionized gas. While conducting experiments in high-temperature electrolysis, we discovered the LEC. Further experimentation and analysis have revealed that the LEC can be improved to become a more general electrophysical direct energy conversion (EDEC) device.

The improvements disclosed herein were derived by studying and integrating the discoveries by Thales, 2,500 years ago, Franklin in the 1700's, Volta and Graham in the 1800's, as well as the physics equations by Maxwell-Boltzmann, Langmuir, Fermi, Darrow and others. By incorporating metallurgical and electrophysical properties and using hydrogen-occluded active materials, we have developed and tested an electrophysical direct energy converter (EDEC) device and derived a physics model that explains the experimental results.

In particular, the implementation of a unique electrophysical direct energy converter (EDEC) cell is achieved when two or more electrodes with different work functions and Fermi levels are electrically connected together such that their Fermi levels equilibrate by the transfer or conduction of electrons through the electrical connection. If a charge transport electrolyte is in contact with the electrodes and sufficient energy is available to overcome the energy that is required to transfer an electron to the electrolyte, the electrodes will revert to their natural state by transporting charge through the electrolyte which completes the circuit and causes the Fermi levels to no longer be in equilibration. When this circuit condition occurs, additional electrons will be transferred or conducted through the electrical connection between the electrodes to re-equilibrate their Fermi levels. This process results in the production of a continuous voltage across and a current through the electrical connection which can include an electrical load impedance. Based on an improved understanding of the electrophysical processes provided by the model and verified by our experimentation, the present invention incorporates improvements over prior discoveries.

### Definitions

For purposes of this disclosure, in addition to standard scientific definitions, the following definitions also apply

Active material: Active material is a material or structure that when incorporated in an EDEC device increases the load current, or load voltage, and their product, the load power. Active materials include hydrogen-occluded hydrogen host materials wherein atomic hydrogen is interstitially occluded in the lattice of the material thereby resulting in additional electrons in the conduction band of the material. Active materials can include bulk materials deposited onto the surface of the material. Active materials also include materials such as nanoparticles or microparticles and, materials such as clusters of nanoparticles or microparticles that are occluded with hydrogen or isotopes of hydrogen. Multiple techniques are known to prepare active materials such as by combinations of temperature and gas pressure in a hydrogen environment, and by electrolytic co-deposition from an aqueous solution. Multiple materials or alloys of materials such as Pd black, Ni black, Pd sponge, Ni sponge, NiTiNOL, bulk Pd, electrodeposited iron, as well as co-deposition procedures such as ion-implantation, sputtering, and vapor deposition can also be used to prepare an active material. Various techniques to apply active materials to another material include printing such as screen printing and 3-D printing. Examples of active material in the form of structures are modifications of the electrodes to provide an altered surface such as protuberances or other surface features that alter the localized electric field between the electrodes. Active materials are not required to be materials that are normally considered to be radioactive. Active particulate material can be made during co-deposition of Pd, Fe, Ni and their alloys onto an electrode from an aqueous electrolyte, some of the active Pd, Fe, Ni, and their alloys particulate separates from the electrode during the co-deposition process and it settles to the bottom of the solution where the active particulate can be mixed in a solid, gel, fluidic, or applied to a solid state electrolyte to increase the ionization of the electrolyte. Several techniques are known to have successfully produced active materials that generate ions.

Cell or Device: A basic cell or device is a combination of electrodes, electrode structures, and an electrolyte configured such that one or more cells form at least one of an Electrophysical Direct Energy Converter (EDEC) device and its physical implementations wherein the electrode and electrolyte materials are selected to react electro-physically but are not required to react electro-chemically. When an external load impedance containing a resistive component is connected between the electrodes, the cell produces at least one of a voltage across the external load impedance and/or a current through the external load impedance. Examples of active material in the form of structures are modifications of the electrodes to provide an altered surface such as physical or mechanical alignment, protuberances, depressions, or other physical features such that the structures change the electric field within the electrolyte that is in contact with the electrodes. An example is charge concentrations on the surface of a metal or semiconductor when the radius of curvature of the surface is small. If the required features are included, a cell can be implemented with solid state semi-conductor technologies.

Charge concentration features: Charge concentration features include depressions and protuberances and active particulates. The smaller the object or the smaller the radius of curvature is on a portion of a large object, the greater the surface charge density and the greater the electric field. At a sharp point, the localized electric field can be very large. In such a large field, the electrons acquire enough energy to facilitate the exchange of charge to the electrolyte. In addition, if the point is negatively charged, it is possible for electrons to be emitted from their surface. Hydrogen-occluded particulate material is an example of a charge concentrator that not only has a small radius of curvature, but it also has an excess of electrons in its conduction band which in combination greatly increases the localized energy available to overcome the energy required to remove electrons.

Charge exchange between electrodes and electrolyte: Charge exchange at the electrode-electrolyte electrical contact interface can occur through several mechanisms. Positive charges in the electrolyte can neutralize negative charges in the high work function electrode and become neutral molecules, electrons can be thermally emitted by the high work function electrode (thermionic emission), electron can be emitted by the high work function electrode by a large electric field (field emission), electrons can be removed from the high work function electrode by the motion of molecules in the electrolyte (triboelectric effect), as well as by other phenomena such as energetic light illuminating the high work function electrode (photoelectric effect) or other quantum effects. Similarly, several of the above charge exchange phenomena can occur at the contact of the electrolyte with the low work function electrode.

Contact potential difference (CPD): Contact potential difference (CPD), also known as the Volta potential difference, is the electrostatic potential difference that exists between two different materials with different work functions and Fermi levels, usually metals or semiconductors. When they are brought into contact, charge transfer equilibrates Fermi levels. Mathematically, eV_{CPD}=Φ_{high}−Φ_{low}, where e is the elementary charge in farads or amp-seconds, V_{CPD} is the contact potential difference in volts, and Φ_{high} and Φ_{low} are the high and low work functions in electron-volts respectively.

Electrophysical Direct Energy Converter (EDEC): A cell or device comprised of two or more electrodes of different work functions and Fermi levels in electrical contact with an electrolyte so that the contact potential difference (CPD) of the electrodes in combination with the electrolyte comprises an electrical circuit such that when an electrical load impedance is connected to the electrodes the cell or device produces at least one of a current through the load impedance and/or a voltage across the load impedance so that power is delivered to the load impedance when both a current and a voltage are produced.

Electrical contact: An electrical contact is a conductive interface that allows electrical current to flow between two components or parts of a circuit such as between two electrodes or between an electrode and an electrolyte. If the electrical contact is a wire, electrons can be transferred from one electrode to the other electrode. If the electrical contact is between an electrode and an electrolyte, electrical charge from one electrode is transferred or exchanged to the electrolyte and subsequently transported to the other electrode. Whereas a wire conducts or transfers electrons, an electrolyte transports charge due to the drift and diffusion of mobile ions and electrons.

Electrochemistry: Electrochemistry is the study of chemical reactions that involve electron transfer and the relationship between chemical and electrical energy to generate electricity. Electrochemical reactions are avoided in an EDEC because they can degrade the production of electricity. An EDEC is not an electrochemical device/battery.

Electrode: An electrode is a conductor through which electricity enters or leaves an object, substance, or region. Electrodes may include materials that have different work functions and Fermi levels. Electrodes may be composites of materials structured to optimize the exchange of electrons to or from an electrolyte. An electrode may include an active material. The electrodes may also include physical features such as those to produce electron concentration points such as depressions and protuberances and active particulates. An electrode or a combination of electrodes may be electrically interconnected and may include perforations, apertures, or open areas such as but not limited to an electrode structure such as a mesh, screen, comb, grid, or perforated plates. Within the EDEC cell, one or more electrodes may form a pair to transfer electrons through an electrical connection that may include a resistive load impedance such that an electrical charge is transported through the electrolyte in contact with the electrodes to complete a circuit.

Electrolyte: An electrolyte is a material that possess mobile charges such as ions as well as electrons that can exchange and transport charge by diffusing under the influence of a concentration gradient, drifting under the influence of an electric field, or by the random motion of the mobile ions. The electrolyte may also include active materials, such as electrode deposited Pd particulate that is occluded with hydrogen, and various additives or active structures to increase the number of electrical charges being transported by and within the electrolyte. Example charge exchange and transport electrolytes are ionized gas, liquids, gels, solids, as well as solid-state materials such as semiconductors and photovoltaics. Dielectric electrolytes are a unique class of materials that combine the properties of both dielectrics and electrolyte since they act as both an insulator (dielectric) and an electrolyte allowing mobile charge to be exchanged and transferred. Example of a dielectric electrolyte are the proprietary polymeric compounds used by electrolytic capacitor manufacturers and conductive dielectric grease. EDEC electrolytes should not react chemically with the electrodes of the cell but should participate physically by transferring charge between the electrodes.

Electrophysics: Electrophysics is the physics of electricity involving the properties of different materials and device configurations that do not involve the shared bonding of electrons between atoms or molecules. Electrophysics can include material properties such as thermal, quantum, as well as metallurgical energy.

Energy: Metallurgical energy can be defined as the energy required to deform the mean position of the atoms and molecules within a substance. Two energy examples are the energy needed to distort a lattice of palladium (Pd) when hydrogen atoms are occluded within the lattice and the energy required to form atomic vacancies within the lattice especially “super abundant vacancies (SAVs).” Chemical energy is the energy of a chemical reaction such as the reaction of the hydroxyl ion with zinc which produces electrical power from liberated electrons when the zinc reacts to form zinc hydroxide and the elemental electrode is consumed.

Fermi level: The Fermi level, in the context of solid-state physics, represents the energy level at which the probability of finding an electron is 50% at a given temperature. This is a crucial concept for understanding the behavior of electrons in materials and EDEC devices, particularly semiconductors and metals, and is closely related to the conductivity of the materials.

Hydrogen: As used herein, hydrogen includes hydrogen gas, its molecules and atoms, hydrogen ions as well as the isotopes and ions thereof such as deuterium gas, its atoms, and deuterium ions but not naturally radioactive tritium gas and its ions. When occluded in a lattice of a hydrogen host material, hydrogen will exist interstitially with its electrons contributing to the conduction band of the hydrogen host material.

Hydrogen host materials: A hydrogen host material is a substance, that occludes atomic hydrogen interstitially in the lattice of a material where the electron of the occluded hydrogen contributes to the conduction band of the material. Examples of materials that occlude atomic hydrogen include palladium (Pd), nickel (Ni), iron (Fe), titanium (Ti), and alloys such as NiTiNOL. Hydrogen host materials may include bulk and/or deposited materials, sponge-like forms such as Fe sponge, Pd black and Ni black, as well as nanoparticles and microparticles and clusters of nanoparticles and microparticles of hydrogen host materials.

Ion: An atom or molecule with a net electric charge due to the loss or gain of one or more electrons. As defined herein, ions include electrons, charged atoms, charged molecules, charged clusters of molecules, and charged particulate clusters of molecules.

Mobile ions: Ions including electrons whose thermal agitation (motion) is not restricted to a fixed location (such as vibration in place like the ions in a crystal) but can move from one location to another location under the influence of temperature (random Brownian motion), concentration gradients (diffusion) or electric fields (drift).

Solid-state and/or semiconductor: In addition to conventional definitions, as described herein, commercial solid-state and/or semiconductor devices can provide the functions of an electrolyte. In addition, they can also provide flexibility to optimize the flux of electrons being transported while also reducing the possibility of chemical reactions.

Voltage or potential difference: The ‘open-circuit’ potential difference, ΔΦ, or voltage, Voc, is the voltage between two electrodes measured by an instrument such as a digital voltmeter (DVM) having a high internal impedance. In characterizing our EDEC, it is important to measure the voltage at multiple resistive loads to observe both the drift and diffusion properties of the EDEC since it is the combination of drift and diffusion where maximum power is produced.

Work Function: The electron work function (is a measure of the minimum energy to extract an electron from the Fermi level. The bulk_work function of a material may change due to changes at the surface of the material such as those caused by oxidation, contamination, and the interaction of ionizing radiation or ions with the surface. The work function of a material can also change due to hydrogen occlusion within the material. In addition, the work function can be increased or decreased by modifications to the surface or its structure either by deposition or incorporating one of secondary and tertiary materials such as by doping, alloying, and structural modification of the lattice material or its surface. The work function is an important feature of the EDEC since the difference in work function of the two materials divided by their unit charge gives their open circuit contact potential difference that supplies the spontaneous voltage of an EDEC.

### BRIEF DESCRIPTION OF THE DRAWINGS

FIG. 1 is illustrative of a first embodiment for an electrophysical direct energy converter (EDEC) cell including a high work function electrode, a low work function electrode, where the electrodes are connected together a resistive load impendence, and an electrolyte located therebetween;

FIG. 2 is illustrative of a modified EDEC cell to that shown in FIG. 1 including a pair of high work function electrodes connected together, a single low work function electrode, and an electrolyte located therebetween;

FIG. 3 is illustrative of another modified EDEC cell to that shown in FIG. 1 including a pair of high work function electrodes in electrical contact, a pair of low work function in electrical contact, wherein the high work function and low work function electrodes are electrically connected together and an electrolyte located therebetween;

FIG. 4 is a plot of experimental electrical data delivered by the EDEC cell of FIG. 3 when the high work function electrodes are nickel metal and hydrogen-occluded palladium particulate, the electrolyte is a photovoltaic semiconductor, the low work function electrodes are magnesium with a thin layer of conductive grease between the magnesium and the semiconductor.

FIG. 5 is a plot of experimental electrical data delivered by the EDEC cell of FIG. 2 when the pair of high work function electrodes are nickel metal and hydrogen-occluded palladium particulates, the low work function electrode is magnesium, and the electrolyte is the treated material used in electrolytic capacitors;

FIG. 6 is a plot of experimental electrical data delivered by the EDEC cell of FIG. 3 when the pair of high work function electrodes are nickel metal and hydrogen-occluded with palladium, one low work function electrode is magnesium, and the electrolyte is a semiconductor in contact with the treated material used in electrolytic capacitors;

FIG. 7 is another plot of experimental electrical data delivered by the EDEC cell of FIG. 2 when the pair of high work function electrodes are nickel metal and hydrogen-occluded palladium particulates, the low work function electrode is conductive grease, and the electrolyte is a semiconductor;

FIG. 8 is another plot of experimental electrical data delivered by the EDEC cell of FIG. 3 when one of the high work function electrodes is a stainless-steel screw with the tip of the screw being covered with hydrogen-occluded palladium particulate, the electrolyte and one of the low work function electrodes is magnesium; and the electrolyte is a mixture of polyethylene glycol and ethylene glycol; and

FIG. 9 is another plot of experimental electrical data delivered by the EDEC cell of FIG. 1 when one of the high work function electrodes is a 1 mm in diameter nickel wire with a contact area of is 0.00787 square cm, the low work function electrode is magnesium, and the electrolyte is a mixture of polyethylene glycol and ethylene glycol.

### DESCRIPTION OF THE PREFERRED EMBODIMENT

For the purpose of promoting an understanding of this invention, several embodiments are described to demonstrate some of the functions, features, and implementations of the Electrophysical Direct Energy Converter (EDEC) as well as selected experimental data and supporting analysis for the described embodiments. It will nevertheless be understood that no limitation of the scope of this invention is intended by the selected embodiments. Moreover, modifications to the described embodiments such as different electrode materials and alloys, different active hydrogen host materials, different electrode preparations, such as sputtering and other deposition techniques, as well as other metallurgical processes, different electrolytes including gases, liquids, gels, solid, solid-state, and semiconductor materials, different cell geometries and configurations including electrical circuits and components, as well as further applications of the EDEC device described herein are not to be considered as limitations to this invention.

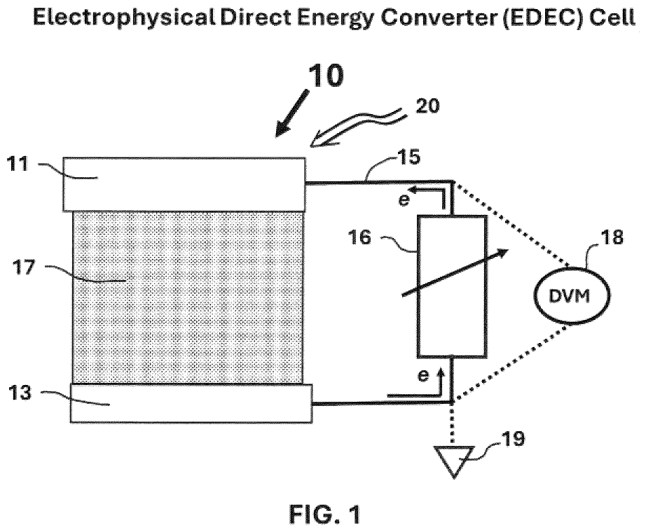

Referring now to the drawings, FIG. 1 illustrates a basic representative phenomenological and physical embodiment of an EDEC cell 10 including a primary first high work function electrode 11 and a primary second low work function electrode 13 connected together by an electrical connection 15 through a resistive load impedance 16. An electrolyte 17 capable of transporting mobile ions or electrons from the high work function electrode to the low work function electrode is in physical and electrical contact with the electrodes 11 and 13. An optional voltmeter 18 to measure the voltage across the resistive load impedance 16 and an optional ground 19 are shown. When the high and low work function electrodes are electrically connected together, their Fermi levels will equilibrate by electrons being transferred or conducted through the electrical connection 15 and the electrical load impedance 16 from the low work function electrode 13 to the high work function electrode 11. This creates a situation where the high work function material will have more electrons than its natural state and the low work function material will have fewer electrons than its natural state. If an electrolyte is in contact with the electrodes, and if there is sufficient energy present to overcome the energy required to remove an electron from the high work function electrode to the electrolyte, electrons will be transported from the high work function electrode 11 to the electrolyte 17. The ions and electrons in the electrolyte 17 will move under the influence of electric field (drift) and concentration gradient (diffusion) from the high work function electrode 11 to the low work function electrode 13 to complete the electrical circuit and cause the Fermi levels to no longer be in equilibrium. To bring the electrodes back to equilibrium, additional electrons are transferred or conducted from the low work function electrode 13 to the high work function electrode 11 through the electrical connection 15 and resistive load impedance 16. As the electrodes constantly re-equilibrate, a spontaneous self-initiating and self-sustaining current is produced through the load impedance 16 and a voltage is produced across the load impedance which can be measured by the optional voltmeter 18. The spontaneous current can be calculated using Ohm's law and the power produced can be calculated by multiplying the calculated current times the measured voltage or by squaring the voltage and dividing by the load resistance.

Multiple parameters such as electrode material selection, electrolyte selection, cell design, and operating temperatures can influence the power produced. In the case of the EDEC cell 10, experimental evidence indicates that increasing the difference in work functions between the electrodes 11 and 13 increases the power produced. In this regard, multiple studies have shown it is possible to significantly increase or decrease the work functions of various materials by selectively incorporating at least one of secondary and tertiary materials. Electrolytes are selected for their ability to exchange and transport charge between the electrodes without involving electrochemical reactions. Some, but not necessarily all of these EDEC design variations and experimental data are presented in subsequent figures.

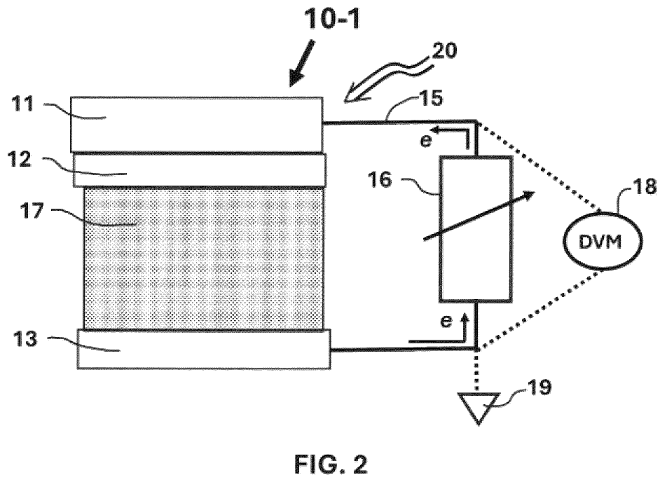

FIG. 2 illustrates a modification to the EDEC cell 10 of FIG. 1 to create a cell 10-1 wherein the high work function electrode 11 includes additional (i.e., secondary) high work function electrode material 12 to facilitate the exchange of electrons to the electrolyte 17. The electrolyte 17 transports charge to be exchanged at the low work function electrode 13. The low work function electrode 13 is electrically connected 15 through an electrical load impedance 16 to the high work function electrode 11. The optional voltmeter 18 and ground 19 also are included. One example of the additional electrode material 12 is hydrogen-occluded particulates to enhance the production and exchange of electrons from the high work function electrode 11 to the electrolyte 17. Experiments have shown that it is beneficial for a composite material high work function electrode to include active material that is interstitially occluded with hydrogen. For each hydrogen atom from a disassociated hydrogen molecule that is interstitially occluded, there will be an extra electron in the conduction band of the material. Hydrogen-occluded particulates with extra electrons in the conduction band on the surface of the electrode also provide charge concentration points which can greatly increase the localized electric field and facilitate the exchange of electrons to the electrolyte to be transported and exchanged to the low work function electrode.

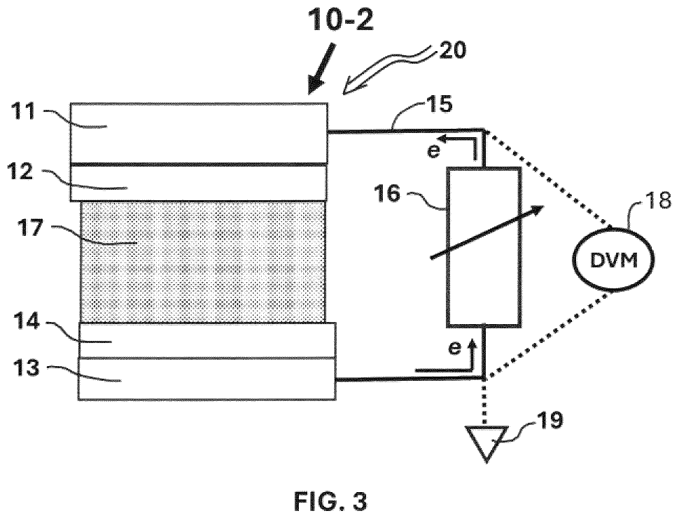

FIG. 3 illustrates another modified cell 10-2 to that shown in FIG. 1 including pairs of high work function electrodes 11 and 12 and low work function electrodes 13 and 14. Materials for the secondary high and low function electrodes 12 and 14 are selected to improve the exchange of electrons to and from the electrolyte 17. The primary and secondary low work function electrodes 13 and 14 are electrically connected 15 through the load impedance 16 to the primary and secondary high work function electrodes 11 and 12. The optional voltmeter 18 and ground 19 also are included. Hydrogen-occluded particulate is one example of material for the secondary high work function electrode 12. Hydrogen-occluded particulates not only have a surplus of electrons in the conduction band but the small size of the particulates can produce localized charged concentration points and increase the localized electric field to overcome the energy required to exchange electrons to the electrolyte. This same particulate material can also be used for the primary high work function electrode 11. The exchange of electrons from the electrolyte 17 to the primary low work function electrode 13 can be enhanced by the addition of materials from the secondary low work function electrode 14 such as those that increase the ability to exchange charge from the electrolyte to the low work function electrode. The selection of the additional materials for the secondary high and low work function electrodes 12 and 14 can vary depending on the electrolyte and the electrodes.

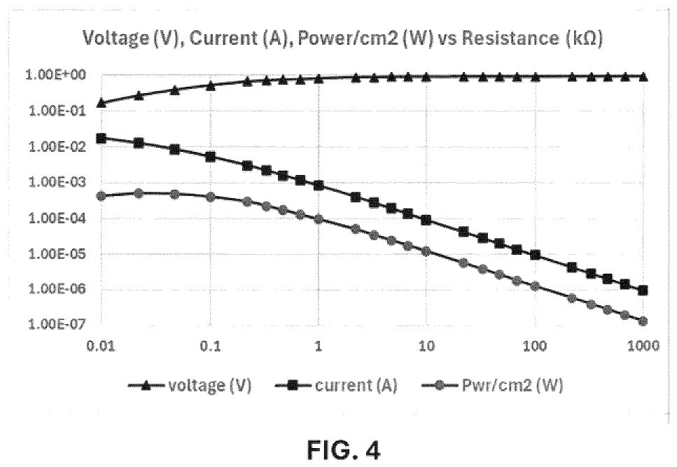

FIG. 4 is a plot of experimental data for the EDEC cell 10-2 illustrated in FIG. 3 where the high work function electrode 11 is nickel metal and the secondary electrode material 12 is hydrogen-occluded palladium particulate, and electrolyte 17 is a photovoltaic semiconductor with the n-side of the semiconductor in contact with the high work function secondary electrode material 12 and the p-side of the semiconductor in contact with a thin layer of conductive grease 14 between the semiconductor and the magnesium low work function electrode 13. As shown, the voltage produced across a 1 MΩ load resistance for this configuration is approximately 1 volt which is close to the contact potential difference for the electrode materials. As the load resistance is reduced, the voltage remains approximately the same while the current and power are increasing. The electric field drift of ions in the electrolyte 17 is the controlling parameter at high load resistances. At low values of the load resistance, the influence of electric field drift on the ions is reduced and diffusion becomes more important. Maximum power occurs where the influence of drift and diffusion are approximately equal which for this test was at a load resistance 16 of approximately 50Ω. The EDEC spontaneously self-initiated and self-sustained the production of a current and voltage without requiring any electrical input, the use of naturally radioactive materials, or chemical reactions.

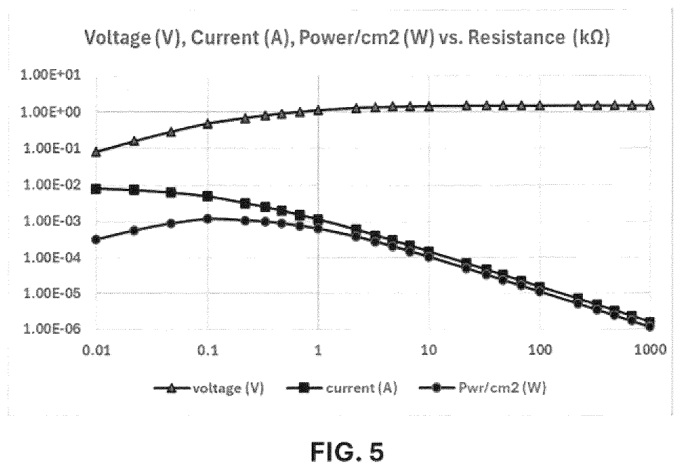

FIG. 5 is a plot of experimental data for the EDEC cell 10-1 illustrated in FIG. 2 where the primary high work function electrode 11 is nickel and the low work function electrode 13 is magnesium. The secondary electrode material 12 is hydrogen-occluded palladium particulate, in contact with the surface of the primary nickel electrode 11 as well as with the electrolyte 17. The electrolyte 17 for this test was specially treated material used in electrolytic capacitors. The cell 10-1 was sealed in hydrogen gas 20 and the temperature at the time of the load test was 27° C. As shown, the voltage produced across a 1 MΩ load resistance for this configuration is approximately 1 volt which is close to the contact potential difference for the electrode materials. As the load resistance is reduced, the voltage remains approximately the same while the current and power are increasing. The electric field drift of ions in the electrolyte 17 is the controlling parameter at high load resistances. At low values of the load resistance 16, the influence of electric field drift on the ions is reduced and diffusion becomes more important. Maximum power occurs where the influence of drift and diffusion are approximately equal which was at a load resistance 16 of approximately 100Ω. The EDEC spontaneously self-initiated and self-sustained the production of a current and voltage without requiring any electrical input, the use of naturally radioactive materials, or chemical reactions.

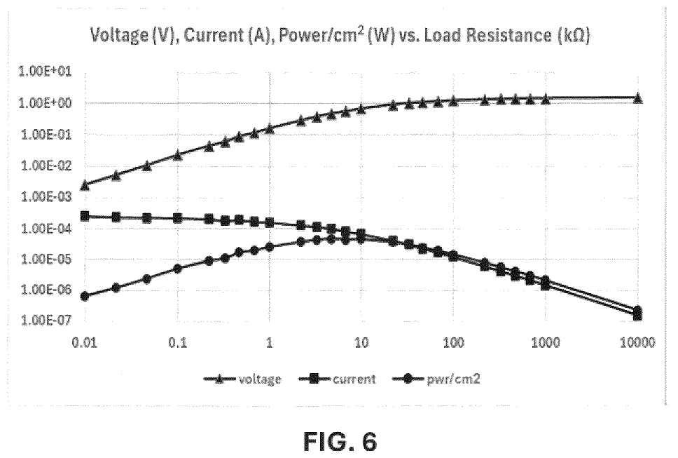

FIG. 6 is a plot of experimental data for an EDEC cell 10-2 illustrated in FIG. 3 where the primary high work function electrode 11 is nickel, and the secondary high work function electrode 12 is hydrogen-occluded palladium particulates on the surface of the nickel. The electrolyte 17 for this experiment is a small photovoltaic p-n semiconductor with the “n” face of the semiconductor lying next to the hydrogen-occluded palladium particulates. The “p” face of the semiconductor is in contact with the aforementioned specially treated material used in electrolytic capacitors which improves the conductivity between the photovoltaic semiconductor and the primary low work function electrode 13 which in this case is magnesium. The cell 10-2 was sealed in hydrogen gas 20 and the temperature at the time of the load test was 27° C. As shown, the voltage produced across a 1 MΩ load resistance for this configuration is approximately 1 volt which is close to the contact potential difference for the electrode materials. As the load resistance is reduced, the voltage remains approximately the same while the current and power are increasing. The electric field drift of ions in the electrolyte 17 is the controlling parameter at high load resistances. At low values of the load resistance, the influence of electric field drift on the ions is reduced and diffusion becomes more important. Maximum power occurs where the influence of drift and diffusion are approximately equal which was at a load resistance 16 of approximately 10,000Ω. The EDEC spontaneously self-initiated and self-sustained the production of a current and voltage without requiring any electrical input, the use of naturally radioactive materials, or chemical reactions.

The electrolyte 17 used to collect the experimental data shown in FIG. 6 may include a thin layer of conductive grease of the secondary low work function electrode 14 placed between the semiconductor and the primary magnesium low work function electrode 13 to improve conductivity. The area of the electrodes in contact with the semiconductor electrolyte material was approximately 1 sq. cm. The temperature for these tests was approximately 26° C. The EDEC spontaneously self-initiated and self-sustained the production of a current and voltage without requiring any electrical input, the use of naturally radioactive materials, or chemical reactions.

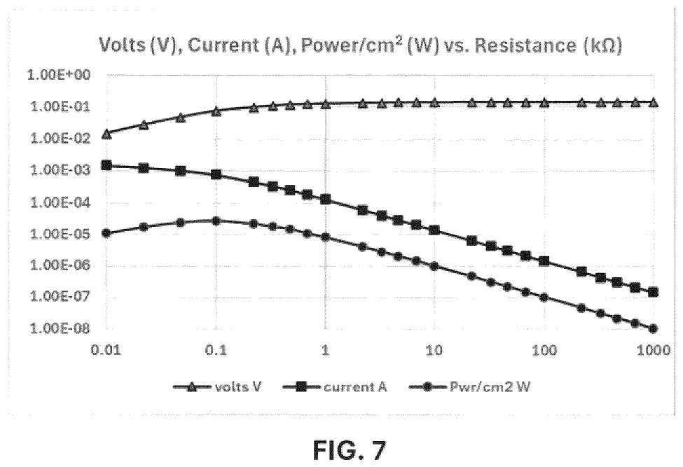

FIG. 7 is another plot of experimental data for the EDEC cell 10-2 illustrated in FIG. 3 where the primary high work function electrode 11 is nickel and the secondary high work function electrode 12 is hydrogen-occluded palladium particulates on the surface of the nickel. The electrolyte 17 for this experiment was a small photovoltaic p-n semiconductor with the “n” face of the semiconductor lying next to the hydrogen-occluded palladium particulate and the “p” face of the semiconductor lying next to a thin layer of conductive grease that is used as the secondary low work function electrode 14 to improve conductivity between the semiconductor and the primary magnesium low work function electrode 13. The area of the electrodes in contact with the semiconductor electrolyte material was approximately 1 sq. cm. The temperature for these tests was approximately 26° C. As shown, peak power for this test occurred at a load resistance of approximately 100Ω. The EDEC spontaneously self-initiated and self-sustained the production of a current and voltage without requiring any electrical input, the use of naturally radioactive materials, or chemical reactions.

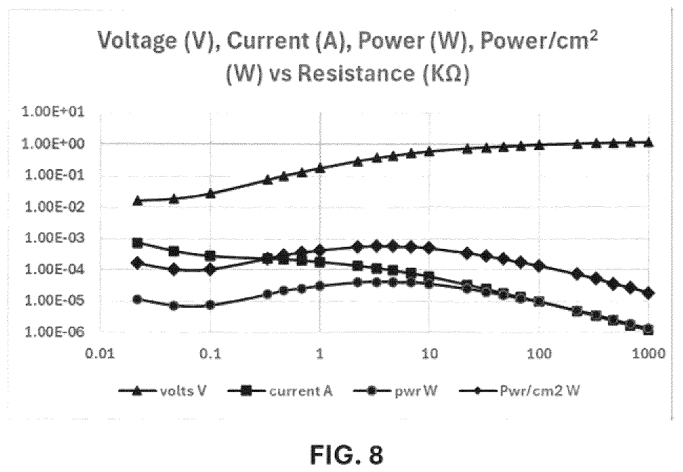

FIG. 8 is another plot of experimental data for an EDEC cell 10-2 illustrated in FIG. 3 where the primary high work function electrode 11 was a 4-40 stainless steel screw that had been ground flat at one end. The screw was screwed into a PTFE sheet that had been drilled through and threaded. A pipette dropper was used to place a secondary high work function material of palladium particulate 12 on the flattened tip of the screw. The screw was then adjusted so that the palladium particulate was slightly recessed from the surface of the PTFE sheet. The electrolyte 17 for this test was a mixture of polyethylene glycol and ethylene glycol. The low work function electrode 13 was magnesium. Peak power occurred at about 5,000Ω. This test illustrates that an EDEC cell can be implemented using small areas which opens the option to produce an EDEC device using the same technologies as those used to produce solid-state electronic components and chips. The EDEC spontaneously self-initiated and self-sustained the production of a current and voltage without requiring any electrical input, the use of naturally radioactive materials, or chemical reactions.

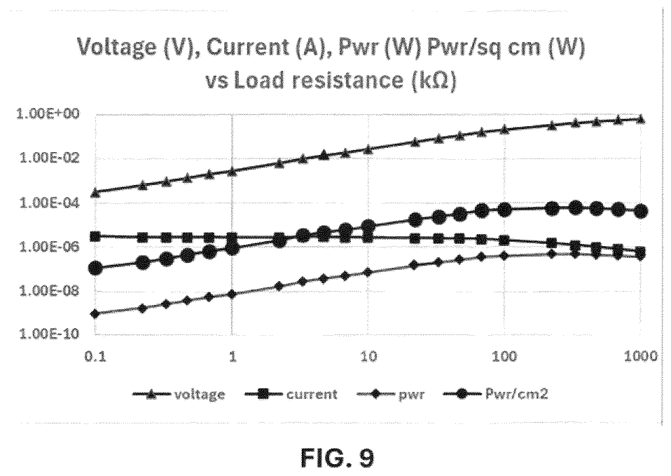

FIG. 9 is another plot of experimental electrical data delivered by the EDEC cell 10 of FIG. 1 where the high work function electrode 11 is a 1 mm diameter nickel wire. The electrolyte 17 is a mixture of polyethylene glycol and ethylene glycol and the low work function electrode 13 is magnesium. The surface area of the 1 mm diameter nickel wire 11 is 0.00787 square cm, This test further illustrates that an EDEC cell can be implemented using small areas which opens the option to produce an EDEC device using the same technologies as those used to produce solid-state electronic components and chips. The EDEC spontaneously self-initiated and self-sustained the production of a current and voltage without requiring any electrical input, the use of naturally radioactive materials, or chemical reactions.

1. An electrophysical direct energy converter (EDEC) cell, comprising:
primary first and second electrodes having respective high and low work functions and different Fermi levels, said primary first and second electrodes being physically separated from one another.
a secondary active material in electrical contact with at least one of said primary first and second electrodes;
an electrical circuit to be completed by which said primary first and second electrodes are connected together, said electrical circuit including an electrical load impedance through which electrons are transferred from said low work function electrode to said high work function electrode that causes the different Fermi levels of said primary first and second electrodes to equilibrate; and
an electrolyte lying in electrical contact with said primary first and second electrodes and said secondary active material to transport electrical charges from the high work function electrode to the low work function electrode so as to complete said electrical circuit by which the Fermi levels in said primary first and second electrodes revert to different Fermi levels and cause electrons to then be transferred from the low work function primary electrode to the high work function primary electrode and through said electrical circuit and the electrical load impedance thereof to produce electrical energy and power.

2. The EDEC cell recited in claim 1, wherein the primary high work function first electrode includes hydrogen-occluded active hydrogen host material.

3. The EDEC cell recited in claim 1, wherein said secondary active material includes a hydrogen host material that lies on the surface of said primary high work function first electrode.

4. The EDEC cell recited in claim 3, wherein said secondary active hydrogen host material lies on the surface of said primary high work function first electrode and said secondary active material.

5. The EDEC cell recited in claim 1, wherein the secondary active material includes hydrogen host particulate materials.

6. The EDEC cell recited in claim 1, wherein said primary high work function first electrode is nickel and said primary low work function second electrode is magnesium.

7. The EDEC cell recited in claim 1, wherein said cell is sealed within a hydrogen gas.

8. The EDEC cell recited in claim 1, wherein said secondary active material includes palladium particulates occluded with hydrogen that lay on the surface of said primary high work function first electrode.

9. The EDEC cell recited in claim 1, wherein said electrolyte includes a semiconductor.

10. The EDEC cell recited in claim 9, wherein said semiconductor is a photovoltaic semiconductor.

11. The EDEC cell recited in claim 1, wherein said electrolyte is a paste of polyethylene glycol and ethylene glycol.

12. The EDEC cell recited in claim 1, wherein said secondary active material is particulates that are dispersed throughout said electrolyte.

13. An electrophysical direct energy converter (EDEC) cell, comprising:
first and second electrodes having respective high and low work functions and different Fermi levels, said first and second electrodes being physically separated from one another;
an electrical circuit to be completed by which said first and second electrodes are connected together, said electrical circuit including an electrical load impedance through which electrons are transferred from said low work function electrode to said high work function electrode to cause said different Fermi levels to equilibrate; and
a electrolyte lying in electrical contact with said first and second electrodes to transport charge from the high work function electrode to the low work function electrode to complete the electrical circuit by which the Fermi levels in said first and second electrodes will revert to different Fermi levels and cause additional electrons to then be transferred from the low work function electrode to the high work function electrode and through the electrical load impedance of said electrical circuit to produce electrical energy and power.

14. The EDEC cell recited in claim 13, where the electrolyte contains mobile ions to transport the charge from the high work function electrode to the low work function electrode.

15. The EDEC cell recited in claim 13, wherein the primary high work function first electrode includes a hydrogen occluded hydrogen host material.
